(19) United States
(12) Patent Application Publication
(10) Pub. No.: US 2005/0259730 A1
(43) Pub. Date: Nov. 24, 2005

(54) Video coding with residual color conversion using reversible YCoCg

(75) Inventor: Shijun Sun, Vancouver, WA (US)

Correspondence Address: DAVID C RIPMA, PATENT COUNSEL;SHARP LABORATORIES OF AMERICA, 5750 NW PACIFIC RIM BLVD, CAMAS, WA, 98607, US

(73) Assignee: Sharp Laboratories of America, Inc.

(21) Appl. No.: 10/951,929

(22) Filed: Sep. 27, 2004

Related U.S. Application Data
(60) Provisional application No. 60/572,346, filed on May 18, 2004.

(51) Int. Cl. H04N 7/12

(52) U.S. Cl. 375/240.03; 375/240.12; 375/240.18

(57) ABSTRACT

A video coding algorithm supports both lossy and lossless coding of video while maintaining high color fidelity and coding efficiency using an in-loop, reversible color transform. Accordingly, a method is provided to encode video data and decode the generated bitstream. The method includes generating a prediction-error signal by performing intra/inter-frame prediction on a plurality of video frames; generating a color-transformed, prediction-error signal by performing a reversible color-space transform on the prediction-error signal; and forming a bitstream based on the color-transformed prediction-error signal. The method may further include generating a color-space transformed error residual based on a bitstream; generating an error residual by performing a reversible color-space transform on the color-space transformed error residual; and generating a video frame based on the error residual.

### CROSS-REFERENCE TO RELATED APPLICATION

This application claims the benefit of a provisional application entitled, VIDEO CODING WITH RESIDUAL COLOR CONVERSION USING REVERSIBLE YCOCG, invented by Shijun Sun, Ser. No. 60/572,346, filed May 18, 2004, which is hereby incorporated herein by reference.

### BACKGROUND OF THE INVENTION

1. Field of the Invention

The present methods generally relate to high quality video coding.

2. Description of the Related Art

FIG. 1 (prior art) is a block diagram illustrating a conventional motion-compensated, block-based, video-coding method 10 that encodes Red-Green-Blue (RGB) data 12 directly for maintaining color fidelity at the expense of coding efficiency. RGB data 12 is introduced and intra/inter prediction 14 is performed producing residue data 15. Residue data may also be referred to as a prediction-error signal, prediction-error data, prediction residue data, or other similar term as understood by one of ordinary skill in the art. For lossy coding, the residue data, or prediction-error signal, 15 is transformed and quantized in the transform/quantization step 16 and subsequently entropy coded 18. For lossless coding, the transform/quantization step 16 is not performed. In both lossy and lossless coding, a bitstream of encoded video data 120 is generated.

FIG. 2 (prior art) is a block diagram illustrating a conventional video-coding method 20 that converts RGB input video data 12 to another color space. Most often in the prior art, the YCbCr color space is used due the lack of correlation between components in the YCbCr color space and the resulting high coding efficiency. However, in a video coding method such as that shown in FIG. 2, there is a loss of color fidelity. RGB data 12 is introduced, and a color-space conversion 23 is performed taking the RGB data 12 to another color space, for example YCbCr, or YCoCg. Intra/inter prediction 24 is then performed generating residue data 25. For lossy coding, the residue data 25 is transformed and quantized in the transform/quantization step 26 and subsequently entropy coded 28. For lossless coding, the transform/quantization step 26 is not performed. In both lossy and lossless coding, a bitstream of encoded video data 120 is generated.

The Joint Video Team (JVT) of ISO/IEC MPEG & ITU-T VCEG developed a Professional Extension for video coding applications requiring high color fidelity. One proposal for retaining high color fidelity and for providing high coding efficiency is disclosed by W.-S. Kim et al. in “Adaptive Residual Transform and Sampling,” JTC1/SC29/WG11 and ITU-T Q6/SG16, Document JVT-K018, March 2004, which is hereby incorporated herein by reference.

FIG. 3 (prior art) depicts the Kim et al. technique 30, in which the the residue data 35 is decorrelated using a color transform 33 after an inter/intra prediction step 34 that is performed on introduced RGB data 12. This is termed in-loop color conversion referring to the fact that the color-space-conversion step 33 is in the coding loop as opposed to prior to the intra/inter frame prediction that is at the beginning of the coding loop. When the color-space-conversion step occurs prior to the intra/inter frame prediction step 34, the process is referred to as out-of-loop, or direct, color conversion. The transform/quantization step 36 and entropy coding step 38 are performed to generate a bitstream of encoded video data 120.

After extensive simulations, the JVT selected the YCoCg transform disclosed by H. Malvar et al. in “Transform, Scaling & Color Space Impact of Professional Extensions,” JTC1/SC29/WG11 and ITU-T Q6/SG16, Document JVT-H031r2, May 2003, to decorrelate the residue data. The Malvar et al. document is hereby incorporated herein by reference. The forward YCoCg color-space transform is defined as:

$$[ \begin{matrix}Δ Y \\ Δ Co \\ Δ Cg\end{matrix} ] = [ \begin{matrix}\frac{1}{4} & \frac{1}{2} & \frac{1}{4} \\ \frac{1}{2} & 0 & - \frac{1}{2} \\ - \frac{1}{4} & \frac{1}{2} & - \frac{1}{4}\end{matrix} ] [ \begin{matrix}Δ R \\ Δ G \\ Δ B\end{matrix} ] ,$$

and the inverse YCoCg color-space transform is defined as:

$$[ \begin{matrix}Δ R \\ Δ G \\ Δ B\end{matrix} ] = [ \begin{matrix}1 & 1 & - 1 \\ 1 & 0 & 1 \\ 1 & - 1 & - 1\end{matrix} ] [ \begin{matrix}Δ Y \\ Δ Co \\ Δ Cg\end{matrix} ] ,$$

in which ΔR, ΔG, and ΔB are the residue data, and ΔY, ΔCo, and ΔCg are the residue transformed data, respectively. In the YCoCg color-space transform, the original RGB channels are mapped into one luma and two chroma channels, or components. While color spaces, such as YCrCb, provide good decorrelation, better results have been obtained using YCoCg. In the YCoCg color space, the Y channel corresponds to luminance. The Co channel is the offset orange channel, and Cg is the offset green channel.

While the YCoCg color conversion process, as defined, requires the encoder to perform only additions and shifts for converting to YCoCg, and the decoder to perform only four additions per pixel for converting back to RGB, the RGB values are not exactly recoverable due to the limitations of integer binary arithmetic. As such, the described YCoCg color transform is not a reversible transform, and the YCoCg transform described is therefore not suitable for lossless coding.

### SUMMARY OF THE INVENTION

The present methods provide a video-coding technique that supports both lossy and lossless coding of video data while maintaining high color fidelity and coding efficiency by using an in-loop, reversible, color transform. Accordingly, a method is provided for encoding video data and for decoding the generated bitstream of encoded video data. The method includes generating a prediction-error signal by performing intra/inter-frame prediction on a plurality of video frames; generating a color-transformed prediction-error signal by performing a reversible, color-space transform on the prediction-error signal; and forming a bitstream of encoded video data based on the color-transformed prediction-error signal.

The method may further include generating a color-space-transformed error residual based on a bitstream; generating an error residual by performing a reversible color-space transform on the color-space transformed error residual; and generating a video frame based on the error residual.

### BRIEF DESCRIPTION OF THE DRAWINGS

Embodiments of the present methods are illustrated by way of example and not by limitation in the accompanying figures in which like reference numerals indicate similar elements and in which:

FIG. 1 is a block diagram of a conventional, prior art video-coding method;

FIG. 2 is a block diagram of a conventional, prior art video-coding method showing out-of-loop color conversion;

FIG. 3 is a block diagram showing prior art in-loop color conversion;

FIG. 4 is a block diagram showing in-loop, reversible, color conversion for lossless encoding;

FIG. 5 is a block diagram showing in-loop color conversion for lossy encoding using a reversible color transform;

FIG. 6 is a rate-distortion curve;

FIG. 7 is a rate-distortion curve;

FIG. 8 is a rate-distortion curve;

FIG. 9 is a rate-distortion curve;

FIG. 10 is a rate-distortion curve;

FIG. 11 is a rate-distortion curve; and

FIG. 12 is a block diagram showing in-loop color conversion for lossy decoding using a reversible color transform.

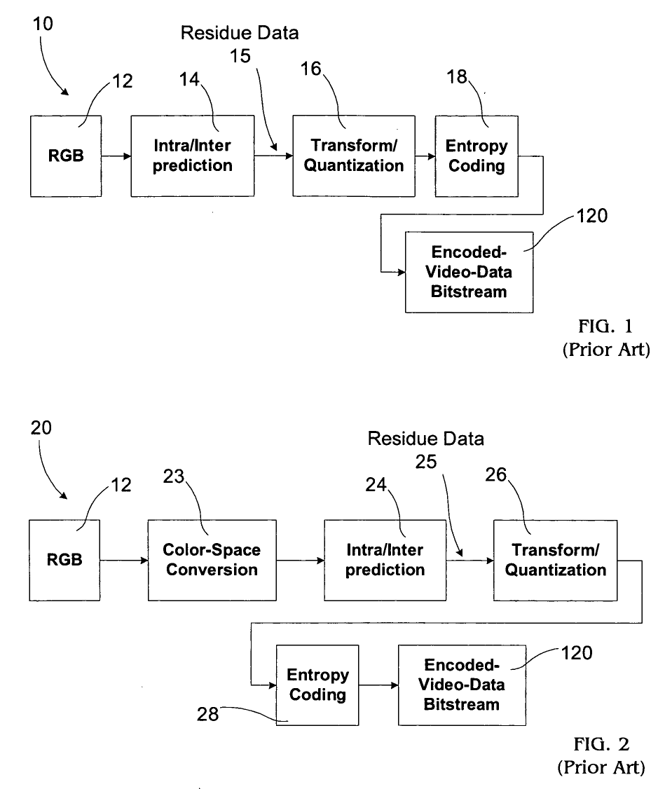

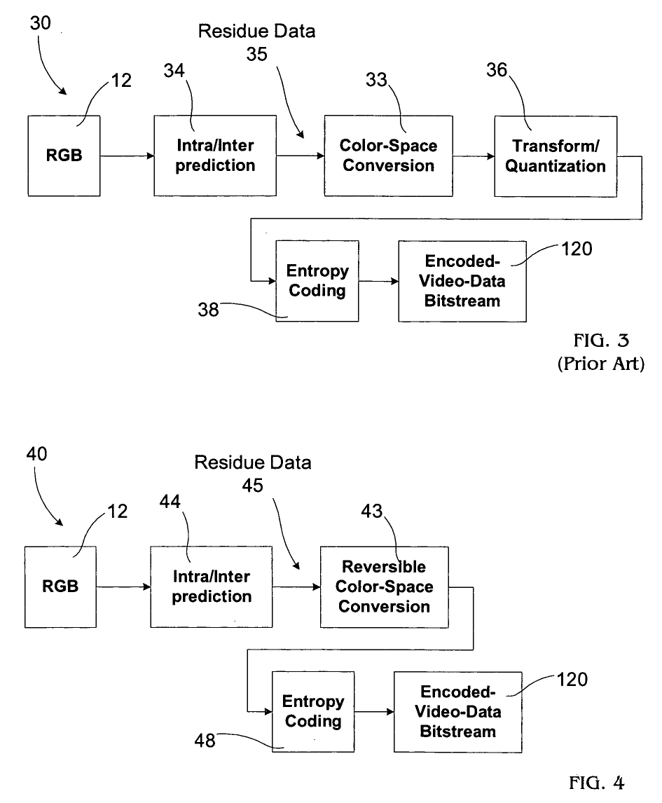

### DETAILED DESCRIPTION OF THE INVENTION

An embodiment of the present methods provides a technique for lossy and lossless compression of video data while maintaining high color fidelity and coding efficiency by using a reversible color transform for decorrelating residue data. The reversible color transform operates on residue data in the coding loop, and as such, provides an in-loop color transform.

H. Malvar et al. teach a reversible color-conversion process, denoted YCoCg-R, from an RGB color space to a YCoCg color space in “YCoCg-R: A Color Space with RGB Reversibility and Low Dynamic Range,” JTC1/SC29/WG11 and ITU-T Q6/SG16, Document JVT-I014r3, July 2003, which is hereby incorporated herein by reference. They disclose that the YCoCg color conversion process may be replaced with a reversible color conversion YCoCg-R. The reversible color transform YCoCg-R is defined as:

$$\begin{matrix}Co = R - B \\ t = B + ( Co ⪢ 1 ) \\ Cg = G - t \\ Y = t + ( Cg ⪢ 1 )\end{matrix} ⇔ \begin{matrix}t = Y - ( Cg ⪢ 1 ) \\ G = Cg + t \\ B = t - ( Co ⪢ 1 ) \\ R = B + Co\end{matrix} ,$$

in which R, G, and B are data in an RGB color space and Y, Co, Cg are a luminance and a chrominance data in a YCoCg color space, and t is a temporary memory location.

The reversible mapping according to Malvar et al. is equivalent to the definition for the color conversion YCoCg, but with Co and Cg scaled up by a factor of two. The YCoCg-R color-space transform is exactly reversible in integer arithmetic. The transform has no increase in dynamic range for the luminance component, Y, and the transform has one bit increase for each of the Co and Cg chrominance components.

Malvar et al. teach out-of-loop, or direct, color-space conversion using the YCoCg-R color transform to decorrelate the RGB input data before the inter/intra frame prediction, thereby allowing for high color fidelity, and lossless compression at the expense of compression efficiency.

An embodiment of the present method uses the YCoCg-R transform in-loop to decorrelate the residue data and as such, the lossless coding case can also benefit in maintaining color fidelity and coding efficiency from the residual color-conversion technique.

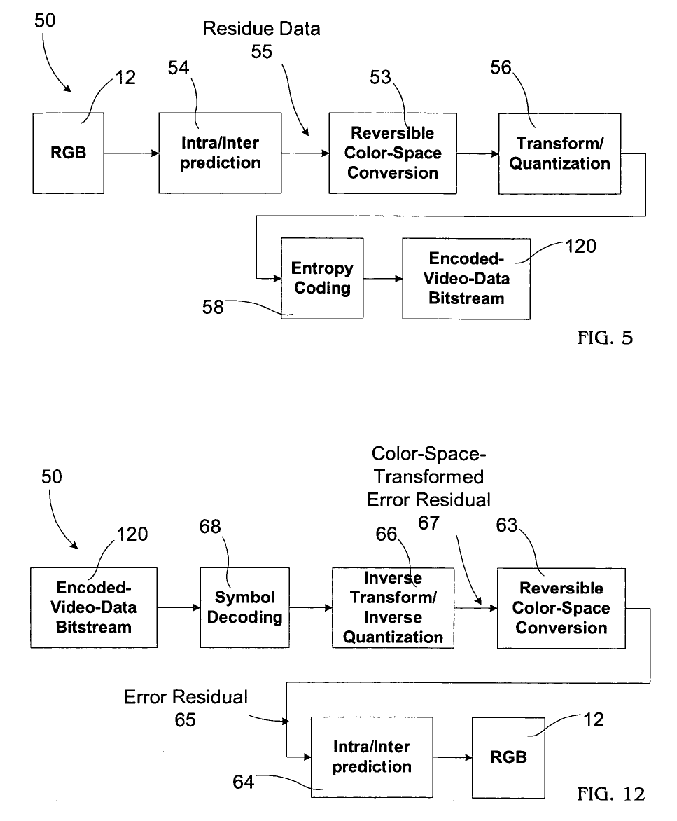

FIG. 4 illustrates a configuration for lossless compression of video data 40 according to the present methods, and FIG. 5 illustrates a configuration for lossy compression of video data 50 according to the present methods. Use of a reversible color transform for the lossy compression of video data requires adjustment of the quantization parameter due to the increase in dynamic range of the Co and Cg components.

FIG. 4 illustrates a lossless video coding process 40 using in-loop color conversion according to the present methods. RGB data is introduced as shown in step 12. Intra-frame and inter-frame prediction is then performed in step 44. A lossless, reversible, color-transform step 43 is provided within the coding loop, and as such, the color transform is performed on the prediction-error data 45. Because a lossless transform is being used in a lossless process, no transform/quantization step is performed between the color transform step 43 and the entropy coding step 48. An encoded-video-data bitstream 120 is generated by the lossless coding.

FIG. 5 illustrates a video coding process 50 for a lossy case using a reversible color transform according to the present methods. RGB data is introduced as shown in step 12. Intra-frame and inter-frame prediction is then performed in step 54. A reversible, color-transform step is provided in the coding loop for prediction-error residuals, residue data 55 as shown at step 53. The reversible, color-transform step 53 converts the prediction-error residuals from RGB color space to YCoCg color space, using a lossless transform, YCoCg-R. The inverse YCoCg-R transform can accurately reconstruct the original RGB values. A transform/quantization step 56 is performed prior to the entropy coding step 58 in this lossy case in which an encoded-video-data bitstream 120 is produced. The quantization process of step 56 takes into account the bit extension used for achieving the YCoCg-R transform. For each value having a bit extension, an adjustment must be made to the quantization parameter (O), for example
Qnew=Qold+Qadj, in which Qadj. represents the adjustment to the quantization parameter.

Thus, when YCoCg-R is used, the quantization parameter for lossy coding is adjusted to account for the one bit extension applied to Co and Cg.

Accordingly, for illustration, in order to balance the intermediate bit depth extension, the quantization parameter for Co and Cg requires an adjustment of six to the QpBdOffset_{c} parameter as defined in the JVT ITU-T Recommendation H.264, also referred to as MPEG-4 Part 10 AVC/H.264, which is hereby incorporated herein by reference. It should be understood this is an adjustment by six of the default H.264 quantization parameter for the chrominance channels that may be wholly communicated to the decoder with a residual color transform flag. Because YCoCg-R does not require a bit extension for the Y component, there is no quantization parameter adjustment for the Y component.

It should be recognized that the previously referenced transform matrix:

$$[ \begin{matrix}Δ Y \\ Δ Co \\ Δ Cg\end{matrix} ] = [ \begin{matrix}\frac{1}{4} & \frac{1}{2} & \frac{1}{4} \\ \frac{1}{2} & 0 & - \frac{1}{2} \\ - \frac{1}{4} & \frac{1}{2} & - \frac{1}{4}\end{matrix} ] [ \begin{matrix}Δ R \\ Δ G \\ Δ B\end{matrix} ]$$

may be multiplied by four to support reversibility in integer arithmetic and hence, lossless coding. The YCoCg reversible transform is denoted herein as YCoCg-R(2). In this embodiment a bit depth extension of two is required in the luminance and both chrominance components, which requires adjustment of the H.264 WpBdOffsetc and WpBdOffsety parameters by twelve.

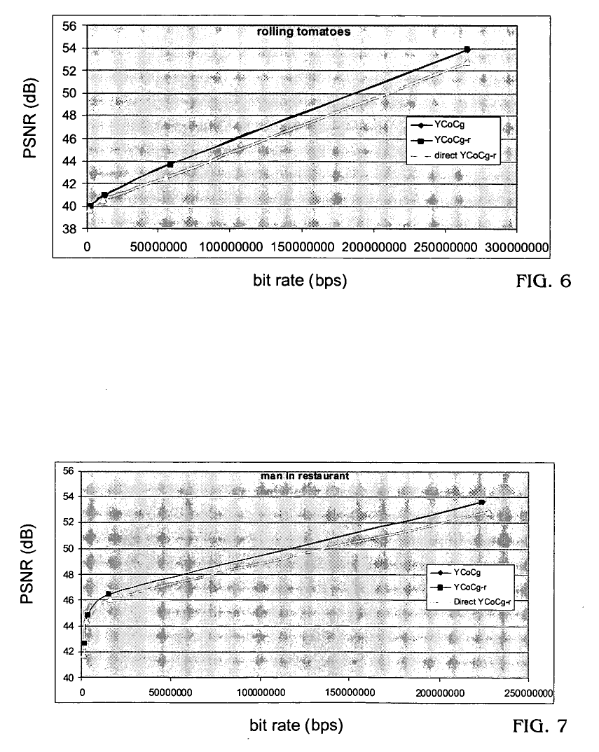

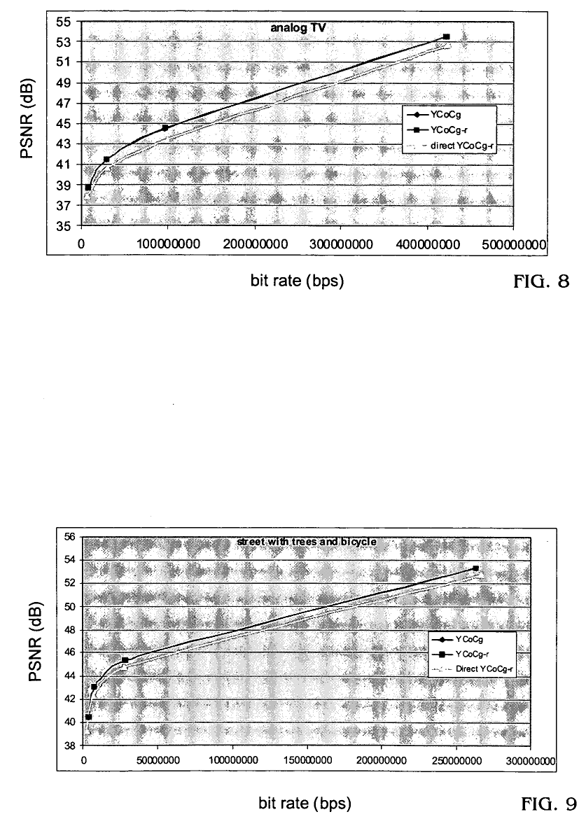

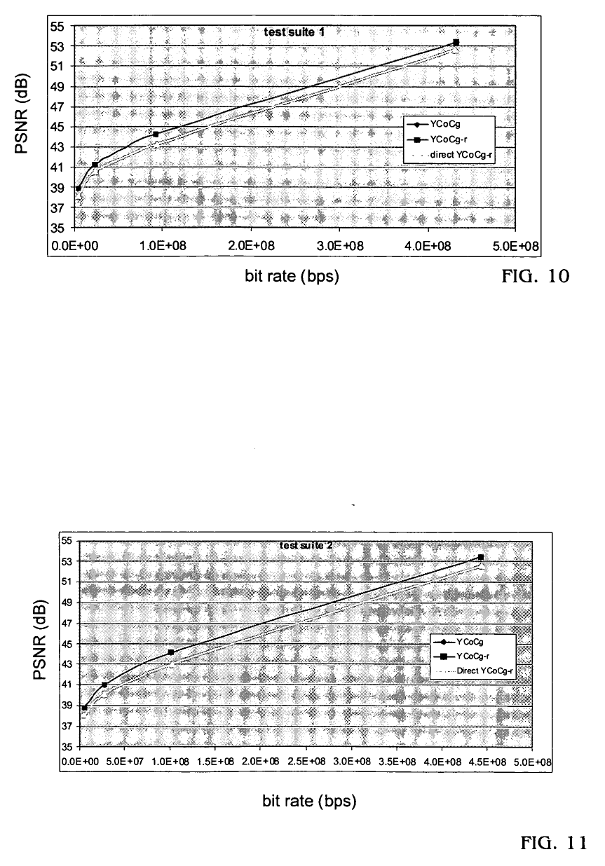

FIGS. 6-11 are Rate/Distortion (RD) curves, which are obtained using various sample video sequences for the luminance component. The RD curves compare the lossy, in-loop YCoCg transform (shown as YCoCg), with the reversible, in-loop YCoCg-R (shown as YCoCg-r), and the direct YCoCg-R case (shown as direct YCoCg-r), which places the YCoCg transform before the coding loop. The curves show peak signal-to-noise ratio (PSNR) in dB versus bit rate in bits per second (bps). The same YCoCg-R transform was used for both the in-loop and direct, or out-of-loop, cases shown in FIGS. 6-11. The RD curves indicated that the in-loop coding performs better than the direct YCoCg case, in a lossy situation. The RD curves also show that the YCoCg-R process matches closely to the performance of the non-reversible YCoCg process in the lossy case.

Although the forward coding direction, encoding, has been described in detail, one skilled in the art will recognize the correspondence in the decoding direction for each embodiment. FIG. 12 depicts the decoder according to an embodiment of the present methods 60 for lossy coding. A color-space-transformed error residual 67 is generated based on a bitstream of encoded video data 120. An error residual 65 is generated by performing a reversible color transform 63 on the color-space-transformed error residual 67. In one embodiment of the present methods, the reversible color-space transform is the YCoCg-R transform.

The color-space-transformed error residual 67 is generated from the inverse transform and inverse quantization 66 of transform coefficients decoded 68 from an encoded video bitstream 120. RGB data is generated as a result of motion compensation based on intra/inter prediction 64. In the embodiment of the decoder corresponding to the encoder embodiment of FIG. 5, the quantization parameter for the chrominance channels is adjusted to account for the additional bit depth introduced in the YCoCg-R color transform. The residual color transform flag will inform the decoder to make the adjustment to the chrominance channels, if necessary.

Although the foregoing methods have been described in some detail for purposes of clarity of understanding, it will be apparent that certain changes and modifications may be practiced that are within the scope of the claims. Accordingly, the present embodiments are to be considered as illustrative and not restrictive, and the invention is not to be limited to the details given herein, but may be modified within the scope the claims and their equivalents.

1. An encoding method, comprising:
generating a prediction-error signal by performing intra/inter-frame prediction on a plurality of video frames;
generating a color-transformed prediction-error signal by performing a reversible color-space transform on the prediction-error signal; and
forming a bitstream based on the color-transformed prediction-error signal.

2. The method of claim 1, wherein at least one of the video frames is in an RGB format.

3. The method of claim 1, wherein the reversible color transform is from an RGB color space to a YCoCg color space.

4. The method of claim 1, wherein forming a bitstream further comprises:
generating a plurality of transform coefficients by performing a spatial transform on the color-transformed prediction-error signal;
obtaining a plurality of quantized coefficients by quantizing the transform coefficients; and
symbol coding the quantized coefficients.

5. The method of claim 4, wherein the video frames are in an RGB format.

6. The method of claim 4, wherein the reversible color transform is from an RGB color space to a YCoCg color space.

7. The method of claim 6, wherein quantizing the transform coefficients further includes a quantization parameter.

8. The method of claim 7, wherein the quantization parameter is related to an H.264 default quantization parameter.

9. The method of claim 8, wherein the quantization parameter is greater than the H.264 default quantization parameter.

10. The method of claim 9, wherein the quantization parameter for a luminance channel is different than a quantization parameter for each of the chrominance channels of the color-transformed prediction-error signal.

11. The method of claim 10, wherein the quantization parameter for the chrominance channels is six greater than the H.264 default quantization parameter.

12. An encoding method, comprising:
generating a prediction-error signal by performing intra-frame prediction on a video frame;
generating a color-transformed prediction-error signal by performing a reversible color-space transform on the prediction-error signal; and
forming a bitstream based on the color-transformed prediction-error signal.

13. The method of claim 12, wherein the video frame is in an RGB format.

14. The method of claim 12, wherein the reversible color transform is from an RGB color space to a YCoCg color space.

15. The method of claim 12, wherein forming a bitstream further comprises:
generating a plurality of transform coefficients by performing a spatial transform on the color-transformed prediction-error signal;
obtaining a plurality of quantized coefficients by quantizing the transform coefficients; and
symbol coding the quantized coefficients.

16. The method of claim 15, wherein the video frames are in an RGB format.

17. The method of claim 15, wherein the reversible color transform is from an RGB color space to a YCoCg color space.

18. The method of claim 17, wherein quantizing the transform coefficients further includes a quantization parameter.

19. The method of claim 18, wherein the quantization parameter is related to an H.264 default quantization parameter.

20. The method of claim 19, wherein the quantization parameter is greater than the H.264 default quantization parameter.

21. The method of claim 20, wherein the quantization parameter is different for a luminance channel and a plurality of chrominance channels of the color-transformed prediction-error signal.

22. The method of claim 21, wherein the quantization parameter for the chrominance channels is six greater than the H.264 default quantization parameter.

23. A video decoding method, comprising:
generating a color-space transformed error residual based on a bitstream of encoded video data;
generating an error residual by performing a reversible color-space transform on the color-space-transformed error residual; and
generating a video frame based on the error residual.

24. The method of claim 23, wherein the reversible color-space transform is from a YCoCg color space to an RGB color space.

25. The method of claim 23, wherein generating a color-space-transformed error residual based on a bitstream further comprises:
generating a plurality of symbols by performing a decoding operation on the bitstream;
generating a plurality of quantized transform coefficients by an inverse transform on at least one of the symbols;
generating a plurality of transform coefficients by performing inverse quantization on at least one of the quantized transform coefficients; and
generating a color-space transformed error residual by performing an inverse transform on at least one of the plurality of transform coefficients.

26. The method of claim 25, wherein the reversible color-space transform is from a YCoCg-space to an RGB-space.

27. The method of claim 25, wherein inverse quantization further includes a quantization parameter.

28. The method of claim 27, wherein the quantization parameter is related to an H.264 default quantization parameter.

29. The method of claim 28, wherein the quantization parameter is greater than the H.264 default quantization parameter.

30. The method of claim 29, wherein the quantization parameter is different for a luminance channel and a plurality of chrominance channels of the quantized transform coefficients.

31. The method of claim 30, wherein the quantization parameter for the chrominance channels is six greater than the H.264 default quantization parameter.
